(19) United States
(12) Patent Application Publication
(10) Pub. No.: US 2008/0265480 A1
(43) Pub. Date: Oct. 30, 2008

(54) Worktable Clamping and Folding Apparatus and Methods for Operating Same

(76) Inventor: Frank Michael John Kent, Arles (FR)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/658,203

(22) PCT Filed: Jul. 26, 2005
(86) PCT No.: PCT/GB05/02919

§ 371 Date: Jan. 23, 2007

(30) Foreign Application Priority Data
Jul. 26, 2004 (GB) 0416601.3
Jul. 26, 2004 (GB) 0416602.1
May 12, 2005 (GB) 0509650.8
May 12, 2005 (GB) 0509651.6

(51) Int. Cl. B25B 5/04; B25B 1/06

(52) U.S. Cl. 269/164; 269/216

(57) ABSTRACT

A worktable clamping apparatus wherein an adjustable clamping jaw is operable between an adjustable mode (allowing both forward and backward movement on a supporting frame and a clamping mode whereby a work piece is clamped by opposing jaws. The clamping mode is selectively effected by actuation of a clamping assembly which prevents backward movement of the adjustable clamping jaw away from the work piece to be clamped. The clamping mode is not effected automatically but is selectively effected by the user. The time taken to clamp a work piece is significantly reduced as compared to conventional clamping apparatus. In a further aspect of the invention, the clamping apparatus can be collapsed into a partially deployed state to allow the “A” frame structure to be used for alternative purposes.

### FIELD OF THE INVENTION

The present invention relates to worktable clamping apparatus and particularly, but not exclusively, to clamping apparatus that facilitates rapid manual positioning of a pair of clamping jaws to clamp a work piece. The invention further comprises a corresponding method for performing said rapid clamping.

### BACKGROUND

Conventional clamping tables consist of both a ‘tightening jaw’ and an ‘adjustable jaw’ mounted on a supporting framework. The tightening jaw is moved by means of two handles which are each associated with a distal end of the tightening jaw. Each handle is connected to a threaded element which, as the handle is turned, rotates within a nut element attached to the underside of the tightening jaw to move the tightening jaw towards the adjustable jaw. The nature of the threaded connection means that the movement of the tightening jaw is necessarily slow.

Conversely, the adjustable jaw may be repositioned over larger distances more quickly than the tightening jaw.

The procedure by which known clamping tables operate to clamp a work piece is as follows. Firstly, using two hands, a user grasps opposing lateral sides of the adjustable jaw to disengage and move it from its position on the supporting framework and fixes it at a selected position spaced from the tightening jaw. The positioning of the adjustable jaw is chosen based upon a visual estimate of the size of the work piece to be clamped between the respective jaws. Using one hand, the user then holds the work piece between the jaws whilst simultaneously using the other free hand to turn first one and then the other of the handles until the jaws fully converge on, and firmly clamp, the work piece.

The adjustable jaw of conventional clamping tables may thus be operated in two modes: (i) the displacement mode in which it may be moved forward and backward along the length of the supporting framework; and (ii) the clamping mode in which it is blocked from moving backwards. On such conventional clamping tables the adjustable jaw is set in clamping mode (Ready Clamping Mode) before the handles and associated clamping threads of the tightening jaw are tightened.

It will be appreciated by users of such conventional clamping tables that, more often than not, multiple turns of each handle are required to clamp a work piece in view of the slow movement of the threaded element through the nut on the underside of the tightening jaw. Moreover, repeated alternate turning of both handles is often required as the tightening jaw gradually advances toward the work piece to be clamped in a zigzag manner.

### SUMMARY OF THE INVENTION

According to a first aspect of the present invention there is provided a worktable clamping apparatus as defined in claim 1.

According to a second aspect of the present invention there is provided a a method of clamping a work piece as defined in claim 14.

### BRIEF DESCRIPTION OF THE DRAWINGS

Embodiments of the invention will now be described, by way of example only, with reference to the accompanying drawings, in which:

FIG. 1 is a schematic partial end view of a first embodimhent showing a first clamping jaw mounted on a supporting framework and a clamping assembly in a non-actuated state so that said jaw is in its adjustable mode;

FIG. 2 is a similar end view to that shown in FIG. 1, showing the clamping assembly in an actuated state so that said jaw is in its clamping mode;

FIG. 3 is a partial side view of the end of a toothed clamping plate closest to its actuating handle;

FIG. 4 is a partial side view of the end of the clamping plate which is remote from its actuating handle;

FIG. 4a is a similar view to that of FIG. 3 showing a locking member block 8a;

FIG. 5 is a side view of a toothed element of the first clamping jaw;

FIG. 6 is a schematic plan view of the toothed element of FIG. 5 at an intermediate position before it is forcibly coupled with the toothed clamping plate of FIGS. 3 and 4;

FIG. 7 is a schematic plan view of the toothed element of FIG. 5 when forcibly coupled with the toothed clamping plate thus placing the first clamping jaw in clamping mode as shown in FIG. 2;

FIG. 8 is a plan view of the first clamping jaw having a double axis to facilitate smooth manual movement of the jaw along the supporting framework; and

FIG. 9 is a side schematic view of the first clamping jaw of FIG. 11.

### DETAILED DESCRIPTION OF THE PREFERRED EMBODIMENTS

A preferred embodiment of the worktable clamping apparatus is illustrated in FIGS. 1-7. FIG. 1 shows a first clamping jaw 1 (hereinafter referred to as the ‘adjustable jaw’) mounted on a jaw support 2 by means of a bolt member 3. A stem of the bolt member 3 extends upwardly and centrally through a slot 5a formed along the upper surface of supporting framework 5, said stem being spaced from the edges of the slot 5a. A flanged head 4 of the bolt member 3 is dimensioned to be larger than the slot 5a such that it engages the underside the supporting framework 5 when the bolt member 3 secures the clamping jaw 1 to the jaw support 2.

The lateral sides of the jaw support 2 extend over the shoulder of the supporting framework 5 to provide directional guidance to the adjustable jaw 1 as it slides thereon. The guidance of the jaw support 2 does not depend on the centrally positioned bolt member 3 since it does not touch the sides of the slot 5a.

A generally cylindrical rotatable member 6, at least a portion of which is threaded (see

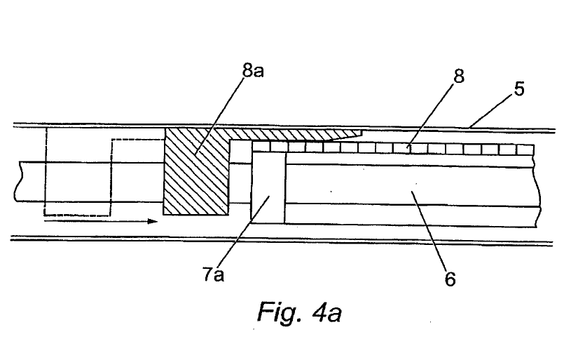

FIG. 4) is positioned under the supporting framework 5 and extends below the flanged head 4 of the bolt member 3. The rotatable member is threadably received within complementary screw threads in a nut member 7 which is formed integrally with a locking member 8. The screw threads have a pitch of approximately 5 mm.

The rotatable member 6 is always threadably engaged within the nut member 7 of the locking member 8 such that the locking member 8 can be said to be integrally formed with the rotatable member 6.

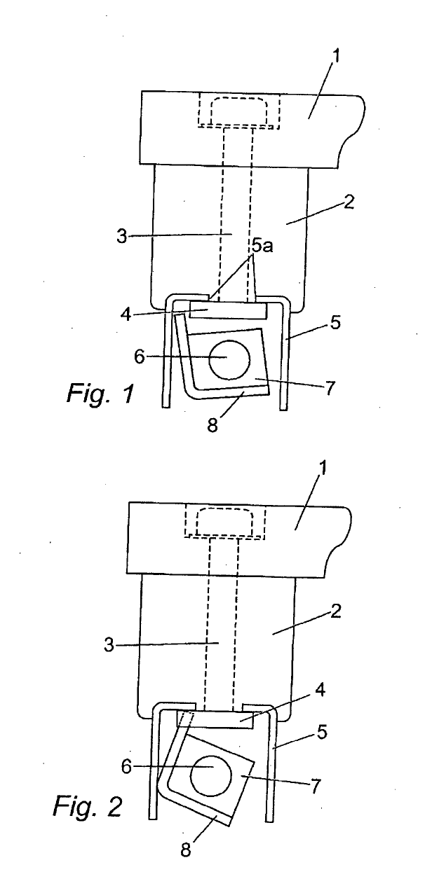

The locking member 8 is mounted concentrically on the rotatable member 6 by means of the nut member 7 and a nut-like supporting member 7a, said members 7, 7a being positioned at opposite distal ends of the locking member 8. The nut-like supporting member 7a has a generally square outer shape in cross section (as shown in FIGS. 1 and 2) and is integrally connected to the nut member 7 via two perpendicularly arranged side walls. However, nut-like supporting member 7a need not be threaded as the thread of the nut member 7 is sufficient to allow operation of the locking member 8.

Only a small portion of the length of the rotatable member need be threaded because the integral locking member never needs to move axially through more than approximately 10 mm, the reasons for which are described in more detail below.

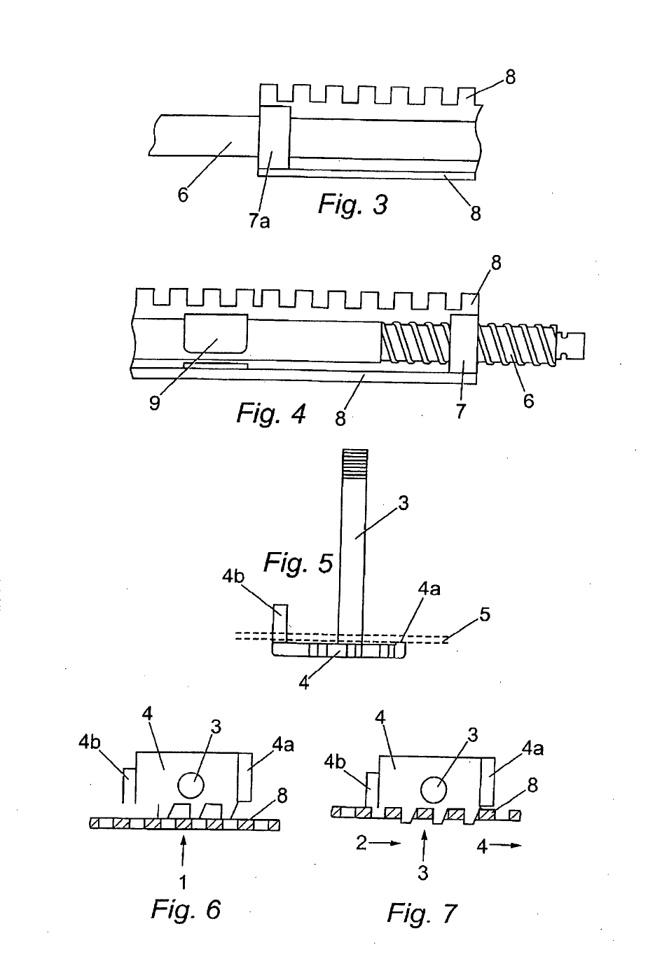

The perpendicularly arranged side walls of the integral locking member 8 are “L” shaped in cross-section as shown in FIGS. 1 and 2. As shown in FIGS. 3 and 4, the upwardly directed edge of the integral locking member is provided with a series of crenelations or tooth-like formations spaced apart at approximately 5 mm intervals. A spring clip 9 extends circumferentially around the rotatable member 6, one end of which is attached to the integral locking member 8. The spring clip 9 is biased into frictional engagement with a portion of the rotatable member 6.

FIG. 4a shows an optional feature of the preferred embodiment which facilitates exact positioning of the adjustable jaw 1 to ensure that its forward edge is in exact parallel alignment with the corresponding edge of the second clamping jaw (not shown). Such parallel alignment is essential when the clamping jaws are used for guiding a power tool over a work piece. In seeking to align the jaws, a user will intuitively rotate the handles (not shown) clockwise and/or anti-clockwise. However, in the absence of the apparatus illustrated in FIG. 4a, anti-clockwise rotation of the handle may cause the integral locking member 8 to disengage from the flanged head 4. In a worse case scenario, disengagement might occur as a power tool is being guided along the jaws over a work piece.

A locking member block 8a fits annularly around the rotatable member 6 and it can be moved between a first position (indicated by dashed lines) where it is separated from the integral locking member 8 and a second position where an outer flanged portion frictionally engages the top of the crenelations or tooth-like formations of the integral locking member.

The bolt member 3 is shown in FIG. 5 in isolation as a side view. The flanged head 4 of the bolt member 3 is also provided with crenelations or tooth-like formations on a lateral edge facing the complementary crenelations or tooth-like formations provided on the upwardly directed edge of the locking member 8. Again, these are spaced apart at approximately 5 mm intervals. Together the locking member 8 and the flanged head 4 define a clamping assembly of the apparatus.

The flanged head 4 is further provided with a raised protuberance 4a which extends approximately 0.5 mm above the general plane of the flanged head 4 from its front edge in a direction parallel to the longitudinal axis of the stem of the bolt member 3. The raised protuberance 4a extends towards, but is spaced from, the underside of the supporting framework 5 which is indicated in FIG. 5 by dashed lines.

A column member 4b extends above the general plane of the flanged head 4 from its rear edge, also in a direction parallel to the longitudinal axis of the stem of the bolt member 3. The column member 4b extends through the slot 5a in the supporting framework 5 and into the jaw support 2 thus benefiting from its directional guidance on the shoulders of the supporting framework to maintain the flanged head 4 in constant precise alignment with its slot 5a.

FIGS. 6 and 7 show plan views of the locking member 8 in two positions relative to the flanged head 4 of the bolt member 3. In particular, the respective crenelations or tooth-like formations formed on the locking member 8 and the flanged head 4 are shown in a first relative position where they merely contact each other, and a second relative position where they interlock, respectively. The operation of the clamping apparatus is described in detail below.

In use, the adjustable jaw 1 is manually slidable along the supporting framework 5 to allow selective clamping of a work piece between it and a second fixed jaw (not shown in FIGS. 1-7). The adjustable jaw 1 is therefore operable between an ‘adjustable mode’ in which it is freely slidable to allow it to accommodate the dimensions of the work piece to be clamped, and a ‘clamping mode’ in which backwards movement away from the work piece to be clamped is prevented.

The adjustable jaw 1 is changed from its adjustable mode (shown in FIG. 1) to its clamping mode (shown in FIG. 2) by actuation of the clamping assembly by manually turning a handle (not shown) to rotate or tighten the rotatable member 6 in a clockwise direction. As the rotatable member 6 is rotated, the nut member 7 also rotates with it due to the frictional forces between the respective members. The spring clip 9 (shown in FIG. 4) contributes towards those frictional forces and ensures smooth rotation of the integral locking member 8 with the rotatable member 6.

Once the crenelations or tooth-like formations on the integral locking member 8 are rotated into contact with the complementary formations on the flanged head 4 (as shown by arrow 1 in FIG. 6), further rotation of the integral locking member 8 is prevented. However, continuing rotation of the rotatable member 6 overcomes the frictional forces between it and the nut member 7 such that the rotatable member 6 rotates relative to the nut member 7. In doing so, the nut member 7 and thus the integral locking member 8 are drawn axially forward along the threaded portion of the rotatable member (in the direction of arrow 2 as shown in FIG. 7).

As the integral locking member 8 is drawn forward, the flanged head 4 of the bolt member 3 remains in a static position. The position of the flanged head 4 is determined by the width of the work piece being clamped between the adjustable jaw 1 and the second fixed jaw (not shown). This position is remains constant due to the fact that a user supports the adjustable jaw 1 against the work piece and maintains a holding force in the direction of the second fixed jaw.

At this point the adjustable jaw is not yet in clamping mode as the holding force may be removed and/or reversed to allow the work piece to fall from between the respective jaws.

As shown in FIG. 7, once the crenelations of the integral locking member 8 have advanced axially to the position where they are aligned with the complementary gaps between the crenelations of the flanged head 4, the frictional engagement between integral locking member 8 and the rotatable member 6 resumes. Accordingly, the integral locking member 8 resumes its rotation in tandem with the rotatable member 6 (as indicated by arrow 3). In doing so, the respective crenelations or tooth-like formations mesh together in an interlocking fashion.

Yet further rotation of the rotatable member 6 once again overcomes the frictional forces between it and the nut member 7 such that the nut member 7 and thus the integral locking member 8 are tightened forward as indicted by arrow 4. The forward movement of the integral locking member 8 is translated into a forward tightening movement of the adjustable jaw to take up any remaining slack between it and the work piece. In doing so, the adjustable jaw 1 is changed from its adjustable mode to its clamping mode.

The initial position of the crenelations or tooth-like formations on the integral locking member 8 relative to those on the flanged head 4 determines the degree of rotation required to place the adjustable jaw 1 into clamping mode. Accordingly, the clamping mode can be viewed as a ‘Delayed Clamping Mode’ (hereinafter referred to as DCM) which is selectively effected by actuation of the clamping assembly.

Given that the width of each crenelation or tooth-like formation is approximately 5 mm, the maximum travel of the integral locking member 8 before the forward tightening movement of the adjustable jaw can take place is therefore approximately 10 mm. This can be achieved within approximately one complete turn of the handle by employing a twin threaded 5 mm pitch rotatable member 6.

It will be appreciated from the foregoing that in the preferred embodiment illustrated by FIGS. 1-7, the adjustable jaw 1 is a dual function jaw since it also acts as the tightening jaw (the second jaw being fixed in position as described above).

In order to release a clamped work piece, the handle is rotated anti-clockwise and the frictional forces between the rotatable member 6 and the nut member 7 immediately cause the integral locking member 8 to move from the position shown in FIG. 2 to that shown in FIG. 1. Accordingly, the change from adjustable mode to clamping mode and from clamping mode back to displaceable mode is effected automatically upon rotation of the rotatable member 6. No modification or regulation of any element or part of the adjustable jaw assembly is required on the part of the operator.

Although only one end of the dual function adjustable jaw 1 is illustrated, it will be appreciated that the other end will be mounted on a parallel supporting framework, each end being controlled by the DCM system described above.

As discussed above, the immediate releasing of the integral locking member upon anti-clockwise rotation of the rotatable member 6 could potentially be problematic should a user inadvertently attempt to adjust the alignment of the jaws. However, by sliding the locking member block 8a into frictional engagement with the integral locking member 8, the respective crenelations or tooth-like formations of the integral locking member 8 and the flanged head 4 are maintained in their meshed position even when the rotatable member is rotated anti-clockwise to adjust the position of one of the jaws. The locking member block 8a therefore acts as a fail safe mechanism in these circumstances.

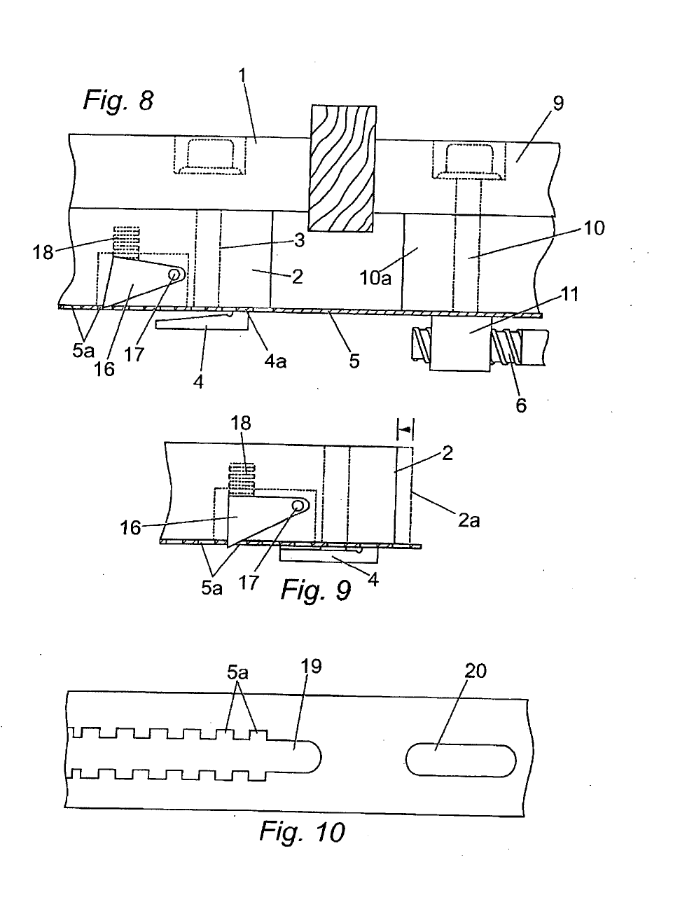

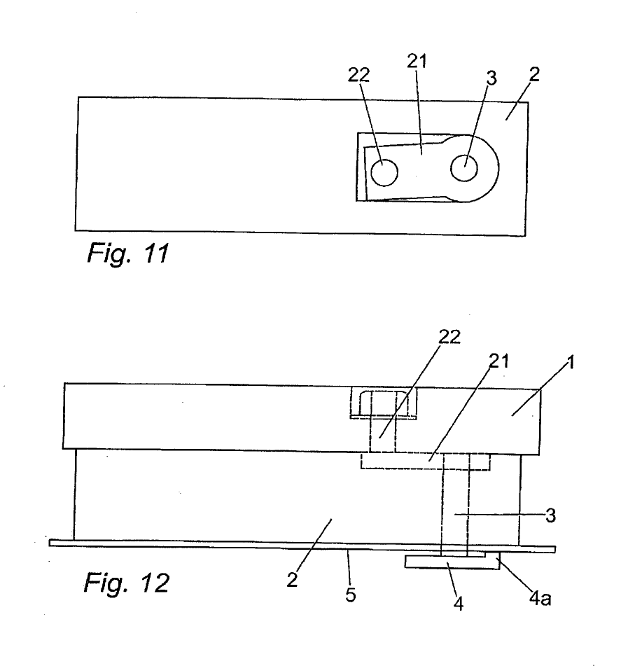

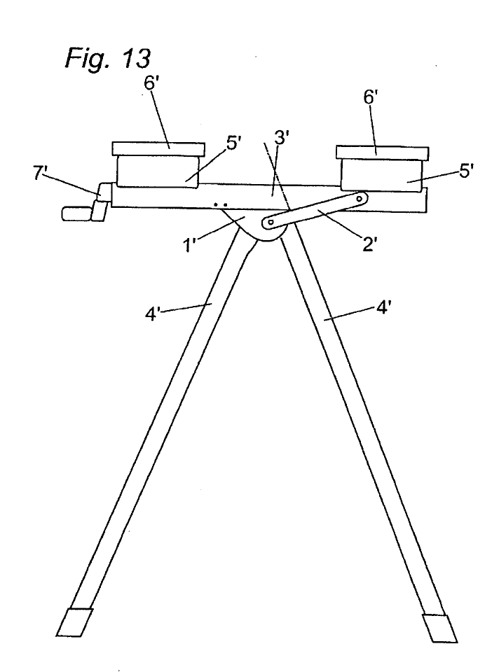

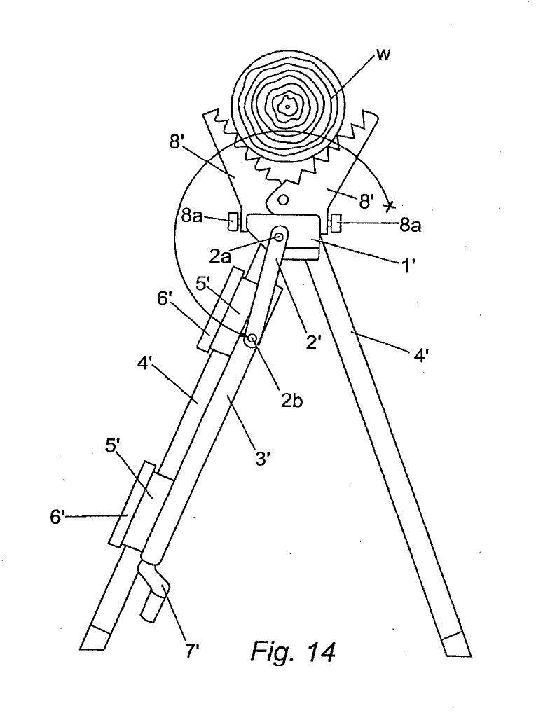

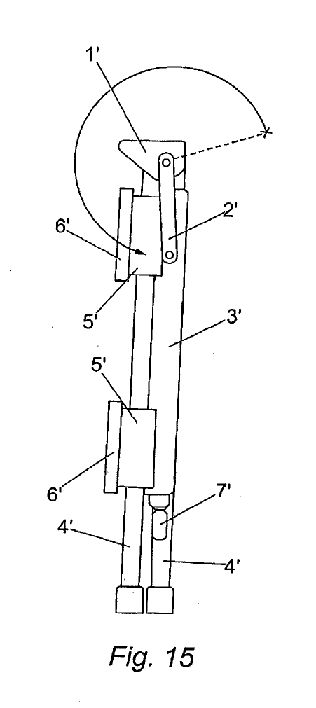

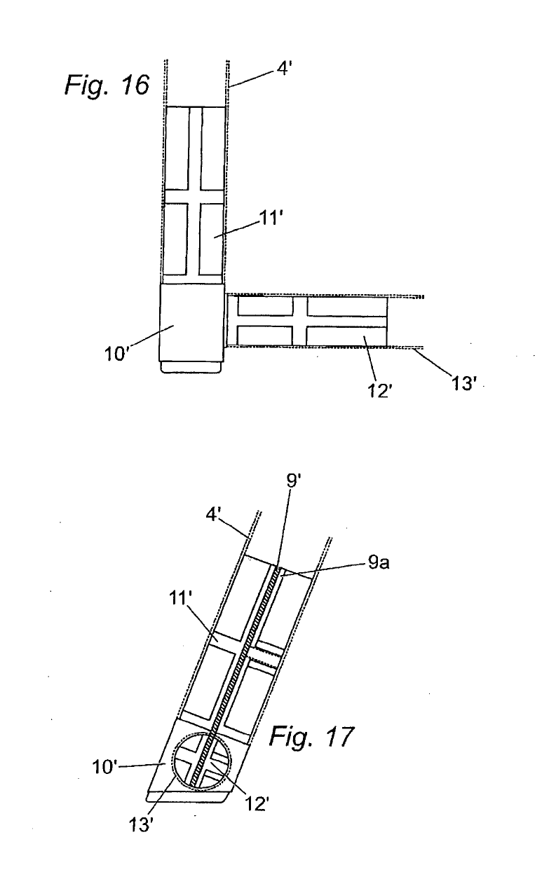

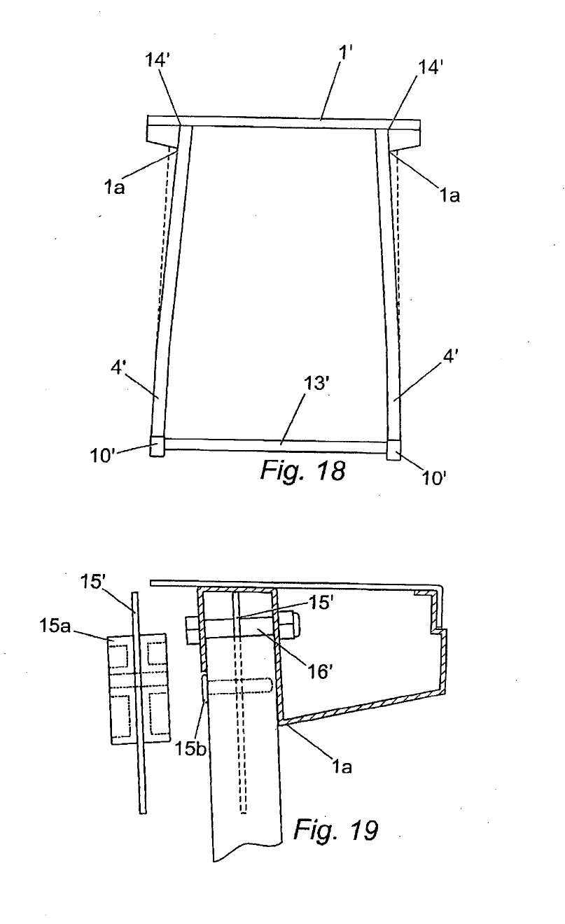

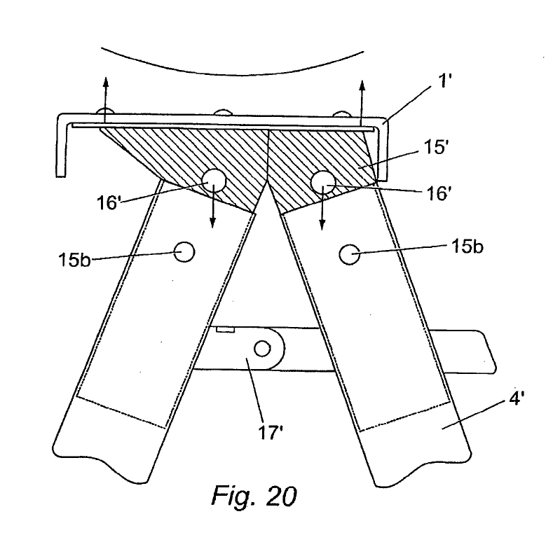

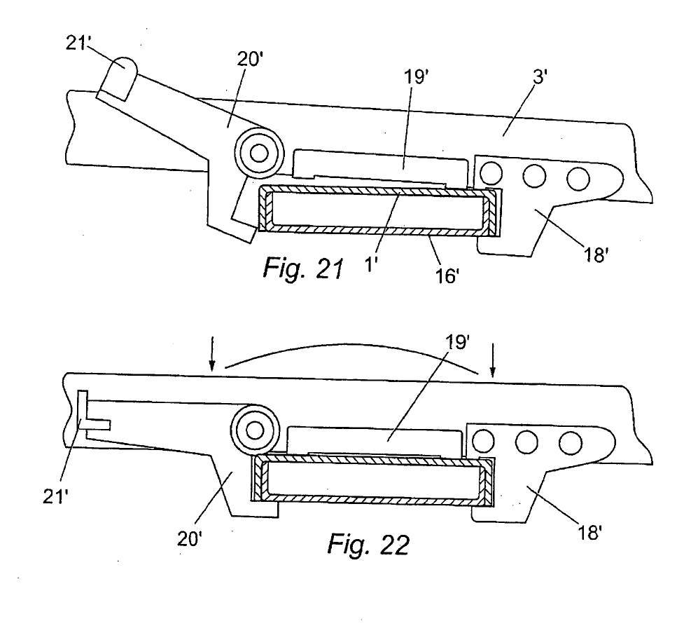

FIGS. 8 and 9 show a plan view and schematic side view respectively of a jaw swivel mount 21 which pivots around the bolt axis 3 and provides a second axis point 22 around which the jaw can pivot. The provision of the jaw swivel facilitates smoother manual adjustment of the adjustable jaw 1 with one hand.

In using the worktable clamping apparatus as described, an operator would perform the following procedure. Firstly, the work piece to be clamped is manually held with a first hand such that it is supported against the fixed jaw. The operator would then use the second free hand to move the adjustable clamping jaw 1 such that it engages the work piece being held by the first hand and applies a manual holding force to the work piece. The manual holding force allows the first hand to be removed from the work piece whilst maintaining the manual holding force with the second hand. The first hand can then be used to place the adjustable clamping jaw 1 into clamping mode by manually actuating the clamping assembly by means of direct movement of an integral locking member.

The advantages of the invention will be apparent to those skilled in the art of worktable clamping arrangements. In particular, it takes approximately one second to manually slide the adjustable jaw forward to hold the work piece against the other fixed/tightening jaw. Also, by using a suitable thread pitch, a single turn on each of the handles (approximately 1.5 seconds per turn) attached to the rotatable members is sufficient to firmly clamp the work piece and place the adjustable jaw 1 into clamping mode. The whole clamping operation is smoother and easier, and in taking a total of approximately 4 seconds, is 2-4 times more rapid than comparable clamping systems.

Modifications and improvements may be made to the foregoing embodiments without departing from the scope of the present invention.

1. Worktable clamping apparatus for releasably clamping a work piece, the apparatus comprising first and second clamping jaws mountable on a supporting framework; the first clamping jaw being selectively operable between an adjustable mode and a clamping mode; the adjustable mode allowing rapid forward and backward movement of the first clamping jaw along the supporting framework between any one of a number of non-clamping positions in which at least one of the first and second jaws is spaced from the work piece to be clamped, and a clamping position in which both jaws engage the work piece to be clamped; the apparatus further comprising a clamping assembly comprising a locking member capable of both rotational and linear displacement with respect to the supporting frame; the clamping assembly being selectively actuatable by rotational and linear displacement of the locking member to forcibly couple complementary interactive formations into clamping engagement and thus prevent backward movement of the first clamping jaw away from the work piece to be clamped; the apparatus being adapted such that movement between said adjustable and clamping modes results in a maximum linear displacement of the locking member which is substantially equal to twice the spacing of said formations, and characterised in that, when in said adjustable mode, there is substantially no linear displacement of the locking member with respect to the supporting frame.

2. Worktable clamping apparatus as claimed in claim 1, wherein said complementary interactive formations are provided on said locking member and said first clamping jaw respectively.

3. Worktable clamping apparatus as claimed in claim 1, wherein the interacting formations are interlockable teeth.

4. Worktable clamping apparatus as claimed in claim 1, wherein the first clamping jaw is adapted for slidable movement along the framework whilst in its adjustable mode.

5. Worktable clamping apparatus as claimed in claim 1, wherein the clamping assembly comprises a clamping actuator formed integrally with the locking member, the clamping actuator adapted to provide the selective actuatation of the locking member.

6. Worktable clamping apparatus as claimed in claim 5, wherein the clamping actuator is a rotatable member provided with screw threads along at least part of its length.

7. Worktable clamping apparatus as claimed in claim 6, wherein the rotatable member is threadably received within corresponding screw threads provided on its integral locking member.

8. Worktable clamping apparatus as claimed in claim 6, wherein the rotatable member and the integral locking member are adapted such that the frictional forces between their cooperating screw threads are sufficient to cause the integral locking member to selectively rotate with the rotatable member.

9. Worktable clamping apparatus as claimed in claim 6, wherein the clamping assembly is adapted to allow selective rotation of the rotatable member relative to the integral locking member such that said linear movement is defined by axial movement of the integral locking member along the screw threads of the rotatable member.

10. Worktable clamping apparatus as claimed in claim 9, wherein the axial movement is in a direction parallel to the supporting framework.

11. Worktable clamping apparatus as claimed in claim 7, wherein the spacing of said formations and the thread pitch of the cooperating screw threads are selectable such that a maximum of one complete rotation of the rotatable member is sufficient to couple the integral locking member into clamping engagement with the first clamping jaw.

12. Worktable clamping apparatus as claimed in claim 9, wherein a blocking member is provided on the rotatable member which is selectively moveable into a position where it frictionally engages both the integral locking member and the supporting framework to maintain the integral locking member in clamping engagement with the first clamping jaw upon counter-rotation of the rotatable member.

13. Worktable clamping apparatus as claimed in claim 1, wherein the second clamping jaw is in a permanently fixed position on the framework and thus a passive element of the apparatus during clamping actuation.

14-24. (canceled)

25. A method of clamping a work piece using the apparatus of claim 1, said method comprising the steps of:
(i) manually holding the work piece to be clamped with a first hand such that it is supported against the second clamping jaw;
(ii) manually moving the first clamping jaw with the second hand such that it engages the work piece being held by the first hand and applies a manual holding force to said work piece;
(iii) removing the first hand from the work piece whilst maintaining said manual holding force with the second hand; and
(iv) selectively placing the first clamping jaw in clamping mode by manually actuating the clamping assembly with the first hand.

26-35. (canceled)
